(19) United States
(12) Patent Application Publication
(10) Pub. No.: US 2009/0220158 A1
(43) Pub. Date: Sep. 3, 2009

(54) IMAGE PROCESSING APPARATUS, IMAGE PROCESSING METHOD, COMPUTER PROGRAM

(76) Inventor: Nobuhiro TSUNASHIMA, Kanagawa (JP)

Correspondence Address: FROMMER LAWRENCE & HAUG LLP, 745 FIFTH AVENUE, NEW YORK, NY, 10151, US

(21) Appl. No.: 12/394,118

(22) Filed: Feb. 27, 2009

(30) Foreign Application Priority Data
Mar. 3, 2008 (JP) P2008-052730

(51) Int. Cl. G06K 9/46

(52) U.S. Cl. 382/201

(57) ABSTRACT

An image processing apparatus 100 according to embodiments of the present invention has an image input section 110 into which an image is input, and a feature point detecting section 120 which detects a feature point on the input image. The feature point detecting section 120 of the image processing apparatus has a primary differential value calculating section 122 which calculates a primary differential value of luminance on a peripheral area of a target pixel as any one pixel on the image, a secondary differential value calculating section 124 which calculates a secondary differential value with respect to the primary differential value, and a detecting section 126 which detects the feature point based on the primary differential value and the secondary differential value.

### CROSS-REFERENCE TO RELATED APPLICATION

The present invention contains subject matter related to Japanese Patent Application JP 2008-052730 filed in the Japan Patent Office on Mar. 3, 2008, the entire contents of which being incorporated herein by reference.

### BACKGROUND OF THE INVENTION

1. Field of the Invention

The present application relates to an image processing apparatus, an image processing method and a computer program which detect a feature point on an image.

2. Description of the Related Art

Angles and corners on images are detected as feature points so that characteristic portions on the images can be detected. For example, according to Japanese Patent Application Laid-Open No. 10-105712 (Patent Document 1), an angle or a corner is detected as feature points on an image so that a dark and bright change portion on the image showing a shape of a mobile object or a pattern of a surface forming the mobile object can be extracted. According to Japanese Patent Application Laid-Open No. 2007-286808 (Patent Document 2), a feature point on a face image is detected, so that a face part such as eyes, a nose, a mouth and the like can be detected. It is very important to detect a feature point on an image.

As means which detects a feature point on an image, methods are described in C. Harris and M. Stephens, “A combined corner and edge detector”, Proc. IEEE Conf. Comput. Vision Patt. Recog., pp. 30-37, Washington, D.C., June 1983 (Non-Patent Document 1), S. M. Smith and J. M. Brady, “SUSAN-a new approach to low level image processing”, Int. J. Compt. Vis., vol. 23, no. 1, pp. 45-78, May 1997 (Non-Patent Document 2), and H. P. Moravec, “Towards automatic visual obstacle avoidance”, Int. Joint Conf. Art. Intell., Cambridge, Mass., USA, P584, August 1977 (Non-Patent Document 3). According to the Non-Patent Document 1, an edge of each pixel on an image can be calculated using a function which is called a Corner/Edge Response Function. According to the Non-Patent Document 2, a line segment of an edge on respective pixels is calculated so that a corner can be detected. According to the Non-Patent Document 3, a difference in luminance between a target pixel and a vicinity pixel are integrated so that a feature point can be calculated.

### SUMMARY OF THE INVENTION

However, in the methods described in the Non-Patent Documents 1 and 2, although a feature point can be detected approximately accurately, very large calculating amount is necessary for detecting the feature point, and thus detecting efficiency is low. On the other hand, in the method of the Non-Patent Document 3, although a feature point can be detected by a simple filter process with the less calculating amount. However, since this method is highly sensitive to a spike-shaped noise, misdetection increases on an image having a lot of noises.

In view of above issue, it is desirable to provide new and improved image processing apparatus, image processing method and computer program which can accurately detect a feature point with a less calculating amount.

According to an embodiment of the present invention, there is provided an image processing apparatus including: an image input section into which an image is input; a primary differential value calculating section which calculates a primary differential value of luminance on a peripheral area of a target pixel as any one pixel on the input image; a secondary differential value calculating section which calculates a secondary differential value with respect to the primary differential value; and a detecting section which detects a feature point based on the primary differential value and the secondary differential value.

According to the present invention, the primary differential value of the luminance on the peripheral area of the target pixel is calculated, so that the luminance change is detected. The secondary differential value with respect to the primary differential value is calculated, and the level of the change amount is detected. The feature point can be detected based on the detected primary differential value and secondary differential value. Since the feature point can be detected by a combination of simple calculating processes of the primary differential value and the secondary differential value, a calculating amount can be reduced, and the feature point can be detected sophisticatedly.

The primary differential value calculating section calculates largeness and a direction of the primary differential value. The secondary differential value calculating section may calculate the secondary differential value in a direction at an acute angle to, for example, perpendicular to the primary differential value.

The detecting section may determine a direction of a feature point based on the direction of the primary differential value. The detecting section can detect a pixel whose both primary differential value and secondary differential value become large as the feature point. At this time, the detecting section can detect, for example, a corner portion present on the image as the feature point.

Further, the detecting section may determine presence/non-presence of the feature point based on a ratio between the primary differential value and the secondary differential value of the luminance on the peripheral area of the target pixel. The target pixel to be detected as the feature point has a feature such that both the primary differential value and secondary differential value become large. The largeness of the primary differential value and the secondary differential value is determined based on a ratio between the primary differential value and the secondary differential value so that a determination can be made whether the target pixel is the feature point.

According to another embodiment of the present invention, there is provided an image processing method for detecting a feature point on an image. The image processing method includes the steps of: calculating a primary differential value of luminance on a peripheral area of a target pixel as any one pixel on the image; calculating a secondary differential value with respect to the primary differential value; and detecting the feature point based on the primary differential value and the secondary differential value.

According to another embodiment of the present invention, there is provided a computer program for operating a computer as an image processing apparatus capable of detecting a feature point on an image. The computer program is stored in a storage apparatus of the computer, and is read by a CPU of the computer to be executed so as to be operated as the image processing apparatus. Further, a recording medium into which the computer program is stored and which is readable by the computer is also provided. Examples of the recording medium are a magnetic disc and an optical disc.

According to the embodiments of the present invention, there can be provided the image processing apparatus, the image processing method and the computer program which can detect a feature point accurately with a less calculating amount.

### BRIEF DESCRIPTION OF THE DRAWINGS

FIG. 1 is a block diagram illustrating a constitution of an image processing apparatus according to a first embodiment of the present invention;

FIG. 2A is an explanatory diagram illustrating a flat portion on an image;

FIG. 2B is an explanatory diagram illustrating an edge portion on the image;

FIG. 2C is an explanatory diagram illustrating a corner portion on the image;

FIG. 3 is a flow chart illustrating an image processing method according to the first embodiment;

FIG. 4A is an explanatory diagram illustrating one example of a filter for calculating a primary differential value and illustrates the filter for a first direction;

FIG. 4B is an explanatory diagram illustrating one example of a filter for calculating a primary differential value and illustrates the filter for a second direction;

FIG. 5 is an explanatory diagram illustrating one example of a filter for calculating a secondary differential value;

FIG. 6A is an explanatory diagram illustrating a relationship between a power P1 of the primary differentiation and a power P2 of secondary differentiation on a flat portion and a state of a target pixel;

FIG. 6B is an explanatory diagram illustrating a relationship between the power P1 of the primary differentiation and the power P2 of the secondary differentiation on an edge portion and the state of the target pixel;

FIG. 6C is an explanatory diagram illustrating a relationship between the power P1 of the primary differentiation and the power P2 of the secondary differentiation on a corner portion and the state of the target pixel;

FIG. 7 is a flow chart illustrating an image processing method according to a second embodiment of the present invention;

FIG. 8A is an explanatory diagram illustrating one example of a filter for calculating a primary differential value and illustrates the filter for the first direction;

FIG. 8B is an explanatory diagram illustrating one example of a filter for calculating the primary differential value and illustrates the filter for the second direction;

FIG. 8C is an explanatory diagram illustrating one example of a filter for calculating the primary differential value and illustrates the filter for a third direction;

FIG. 8D is an explanatory diagram illustrating one example of a filter for calculating the primary differential value and illustrates the filter for a fourth direction;

FIG. 9A is an explanatory diagram illustrating one example of a filter for calculating the secondary differential value and illustrates the filter for the first direction;

FIG. 9B is an explanatory diagram illustrating one example of a filter for calculating the secondary differential value and illustrates the filter for the second direction;

FIG. 9C is an explanatory diagram illustrating one example of a filter for calculating the secondary differential value and illustrates the filter for the third direction;

FIG. 9D is an explanatory diagram illustrating one example of a filter for calculating the secondary differential value and illustrates the filter for the fourth direction;

FIG. 10A is an explanatory diagram illustrating another example of the filter for calculating the secondary differential value and illustrates the filter for the first direction;

FIG. 10B is an explanatory diagram illustrating another example of the filter for calculating the secondary differential value and illustrates the filter for the second direction;

FIG. 10C is an explanatory diagram illustrating another example of the filter for calculating the secondary differential value and illustrates the filter for the third direction;

FIG. 10D is an explanatory diagram illustrating another example of the filter for calculating the secondary differential value and illustrates the filter for the fourth direction; and

FIG. 11 is a flow chart illustrating the image processing method according to a third embodiment of the present invention.

### BRIEF DESCRIPTION OF THE PREFERRED EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

### First Embodiment

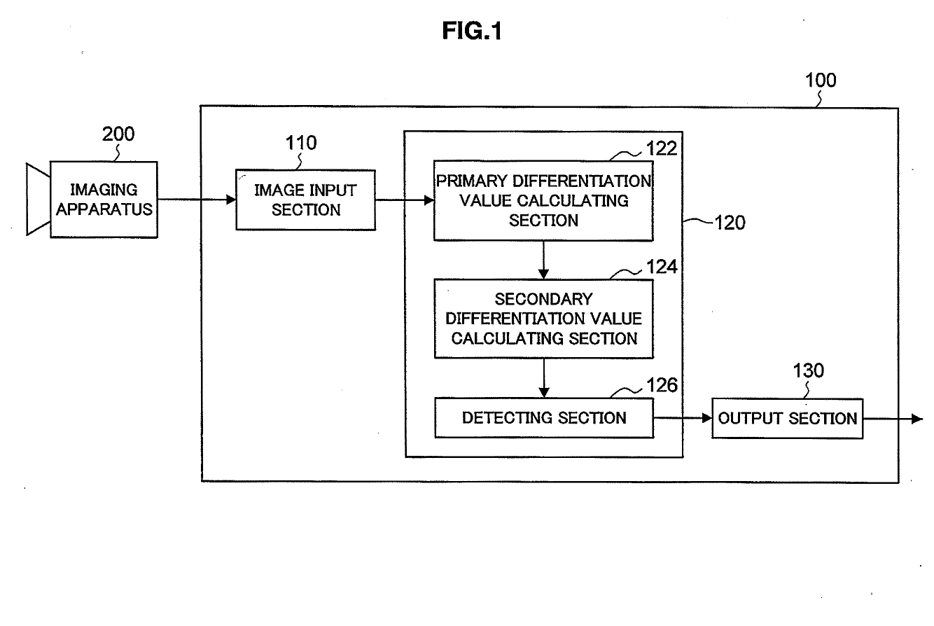

An image processing apparatus 100 according to a first embodiment of the present invention is described with reference to FIG. 1. FIG. 1 is a block diagram illustrating a constitution of the image processing apparatus 100 according to the first embodiment.

The image processing apparatus 100 according to the first embodiment includes an image input section 110, a feature point detecting section 120 and an output section 130 as shown in FIG. 1.

An image taken by an imaging apparatus 200 is input as image data into the image input section 110. The image data input into the image input section 110 is output to a feature point detecting section 120, described later.

The feature point detecting section 120 is a function section which detects a feature point on an image, and includes a primary differential value calculating section 122, a secondary differential value calculating section 124 and a detecting section 126.

The primary differential value calculating section 122 is a function section which calculates a primary differential value on a peripheral area of a target pixel as any one pixel on an image. The primary differential value calculating section 122 in the first embodiment calculates a power representing a level of the primary differentiation and a direction of the primary differential value on the target pixel based on the calculated primary differential value.

The secondary differential value calculating section 124 is a function section which calculates a secondary differential value with respect to the primary differential value calculated by the primary differential value calculating section 122. The secondary differential value calculating section 124 calculates a power representing a level of the secondary differentiation of the target pixel based on the calculated secondary differential value.

The detecting section 126 is a function section which detects a feature point on an image based on the direction and the power of the primary differential value and the power of the secondary differential value. The detecting section 126 outputs the detected feature point to the output section 130.

The output section 130 is a function section which outputs the feature point input from the detecting section 126 to an external apparatus.

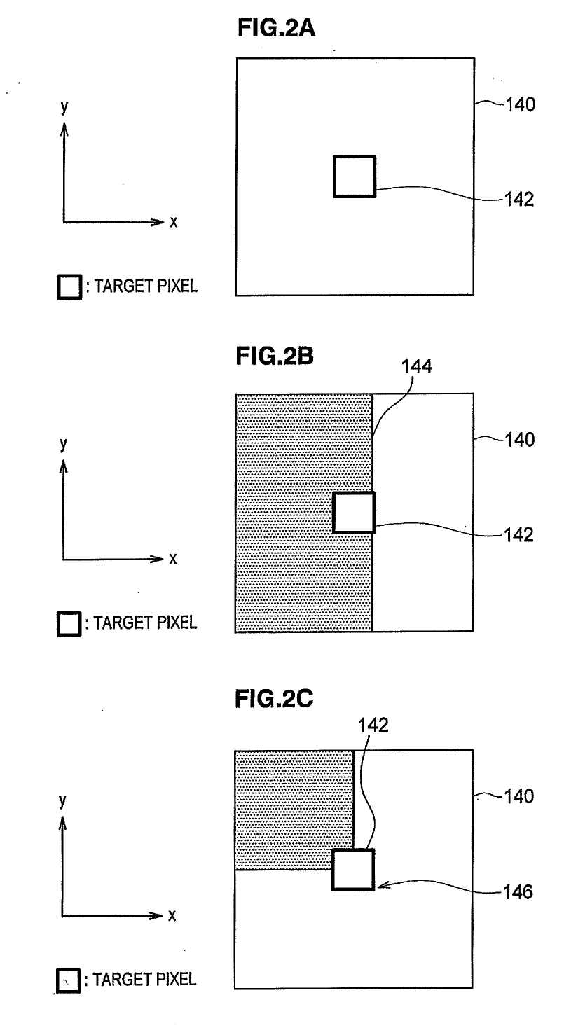

The constitution of the image processing apparatus 100 according to the first embodiment is described above. The image forming apparatus 100 according to the first embodiment detects a corner portion present on an image. Three states including a flat portion shown in FIG. 2A, an edge portion shown in FIG. 2B and a corner portion shown in FIG. 2C are present on an image. As shown in FIG. 2A. the flat portion is in a state such that the luminance value does not change on a peripheral area of a target pixel 142 on an image 140. As shown in FIG. 2B, the edge portion 144 is in a state such that the luminance changes stepwise on the peripheral area of the target pixel 142. As shown in FIG. 2C, the corner portion 146 is in a state such that the luminance changes stepwise in two directions of the peripheral area of the target pixel 142.

When a mobile object of the image 140 is extracted as a feature point, it is desirable that a pixel on two continuous images whose luminance changes, namely, the corner portion 146 is extracted as a feature point. This is because it is difficult to detect a moving direction of the mobile object on the flat portion shown in FIG. 2A due to luminance change, and it is difficult to detect the movement in a direction where the luminance does not change on the edge portion shown in FIG. 2B. Therefore, the image processing apparatus 100 according to the first embodiment detects the corner portion 146 as a feature point on the image 140.

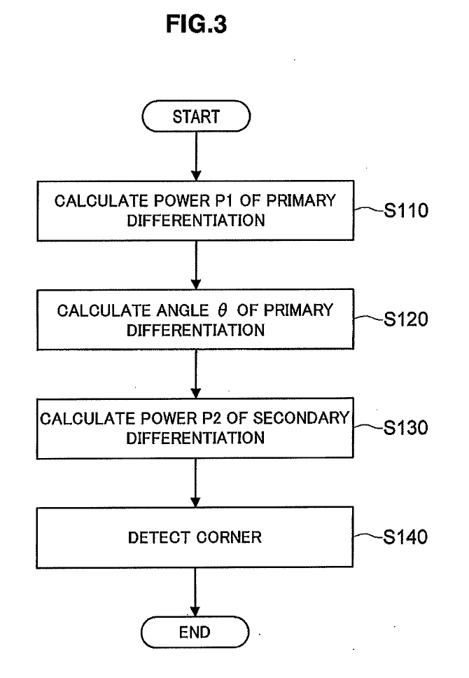

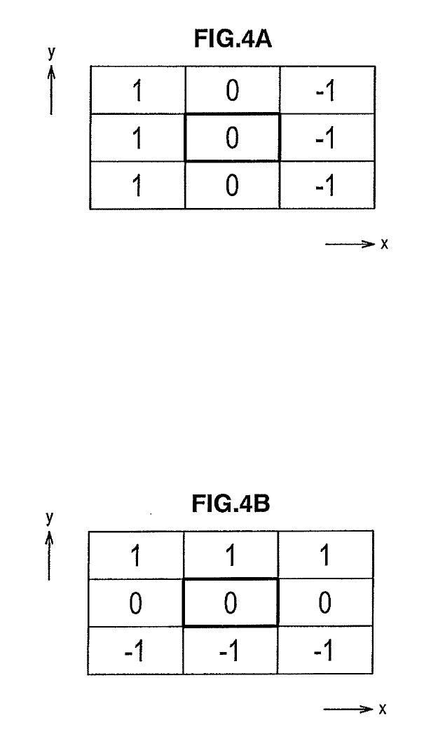

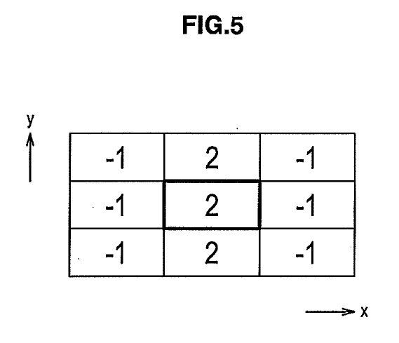

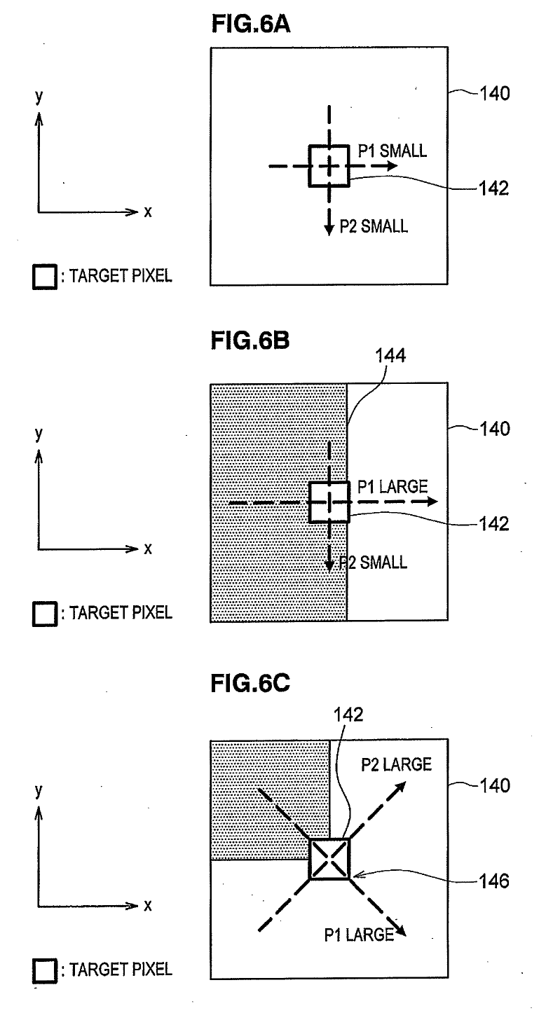

An image processing method for detecting a feature point on an image in the image processing apparatus 100 according to the first embodiment is described below with reference to FIGS. 3 to 6C. FIG. 3 is a flow chart illustrating the image processing method according to the first embodiment. FIGS. 4A and 4B are explanatory diagrams illustrating one example of a filter for calculating a primary differential value, FIG. 4A illustrates the filter for a first direction, and FIG. 4B illustrates the filter for a second direction. FIG. 5 is an explanatory diagram illustrating one example of the filter for calculating a secondary differential value. FIGS. 6A to 6C are explanatory diagrams illustrating a relationship between a power P1 of the primary differentiation and a power P2 of the secondary differentiation and a state of the target pixel. FIG. 6A illustrates the flat portion, FIG. 6B illustrates the edge portion and FIG. 6C illustrates the corner portion.

In the image processing method according to the first embodiment, as shown in FIG. 3, the primary differential value on the peripheral area of the target pixel on the image is calculated, and the power P1 as the primary differential value is calculated (step S110). Nine pixels are present on the peripheral area of one target pixel. At step S110, a level of the luminance change from the target pixel on the image input from the image input section 10 into the peripheral area is calculated. An x component gx and a y component gy of the primary differential value on an input image I can be calculated according to the following Formulas 1 and 2 using a filter Gx for an x direction (first direction) shown in FIG. 4A and a filter Gy for a y direction (second direction) shown in FIG. 4B.

### [Formula 1]

$$\begin{matrix}{g}_{x} = {\sum }_{i = - 1}^{l} {\sum }_{j = 1}^{l} I ( x + i , y + j ) {G}_{x} ( i , j ) & ( Formula 1 ) \\ {g}_{y} = {\sum }_{i = - 1}^{l} {\sum }_{j = 1}^{l} I ( x + i , y + j ) {G}_{y} ( i , j ) & ( Formula 2 )\end{matrix}$$

When the respective components of the primary differential value are calculated, the power P1 of the primary differential value is calculated according to the following Formula 3.

### [Formula 2]

P1=\sqrt{gₓ²+g_{y}²} (Formula 3)

An angle θ of the primary differential value is calculated (step S120). At step S120, a direction where the luminance change from the target pixel on the image into the peripheral area is large is calculated. The angle θ of the primary differential value is calculated according to the following Formula 4.

### [Formula 3]

θ=arctan(g_{y}/gₓ) (Formula 4)

Further, the secondary differential value is calculated (step S130). At step S130, an inflection point with respect to the primary differential value calculated at step S110 is calculated. In the first embodiment, a value in a direction which is shifted from the primary differential value by about 90° (2/π). At this time, the secondary differential value can be calculated according to the following Formulas 5 to 7 by using a filter L shown in FIG. 5.

### [Formula 4]

$$\begin{matrix}{x}^{′} = x cos ( θ + 2 / π ) + y sin ( θ + 2 / π ) & ( Formula 5 ) \\ {y}^{′} = x sin ( θ + 2 / π ) + y cos ( θ + 2 / π ) & ( Formula 6 ) \\ P 2 = \vert {\sum }_{i = - 1}^{l} {\sum }_{j = 1}^{l} I ( {x}^{′} + i , {y}^{′} + j ) L ( i , j ) \vert & ( Formula 7 )\end{matrix}$$

Thereafter, the corner portion 146 as the feature point is detected (step S140). A relationship among the flat portion, the edge portion and the corner portion present on the image, the power P1 of the primary differentiation and the power P2 of the secondary differentiation is described with reference to FIGS. 6A to 6C. In the case of the flat portion shown in FIG. 6A, since the luminance does not change, both the power P1 of the primary differentiation and the power P2 of the secondary differentiation become small. In the case of the edge portion 144 shown in FIG. 6B, the power P1 of the primary differentiation becomes large due to the luminance change from a dark portion into a bright portion. However, the power P2 of the secondary differentiation in a direction vertical to the direction of the primary differentiation becomes small. In the case of the corner portion 146 shown in FIG. 6C, both the power P1 of the primary differentiation and the power P2 of the secondary differentiation become large. That is to say, in order to detect the corner portion 146 as the feature point, a target pixel in which the power P1 of the primary differentiation and the power P2 of the secondary differentiation are large may be extracted.

Therefore, when a function for obtaining a feature point likeness based on the power P1 of the primary differentiation and the power P2 of the secondary differentiation is determined as f (P1, P2), the function f (P1, P2) is designed so that when both P1 and P2 become large, the output value becomes large (or small). For example, the function f (P1, P2) can be designed according to the following Formula 8 or 9.

### [Formula 5]

f(P1, P2)=P1×P2 (Formula 8)

f(P1, P2)=mP1+nP2 (Formula 9)

In the Formula 9, m and n are constants, and the output value of the f (P1, P2) is determined by weighting of P1 and P2. The feature point likeness can be detected based on the function f (P1, P2). The output value of the function f (P1, P2) is subject to a threshold process or a maximum value process for determining the output value as the feature point when the output value is more than a predetermined value, so that the corner portion 146 can be detected.

The image processing method for detecting the feature point on the image according to the first embodiment is described above. According to the image processing method, calculated results of the primary differentiation and the secondary differentiation on the peripheral area of the target pixel are combined, so that the feature point likeness can be detected. Since the feature point likeness can be detected by a simple process, it can be detected sophisticatedly with a less calculating amount.

### Second Embodiment

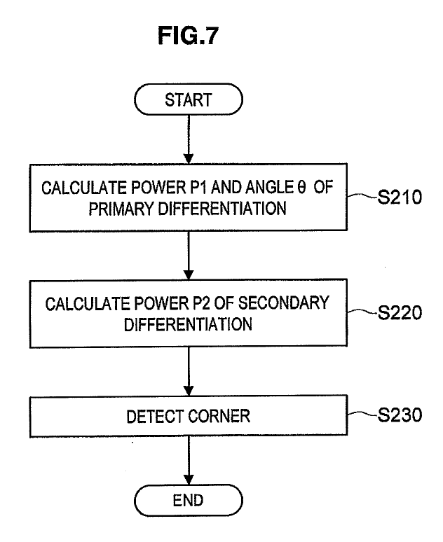

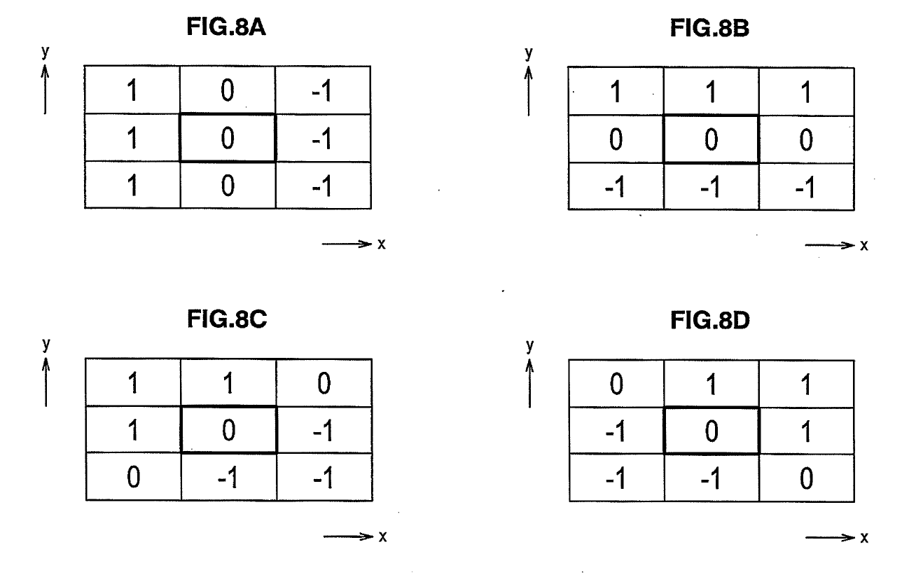

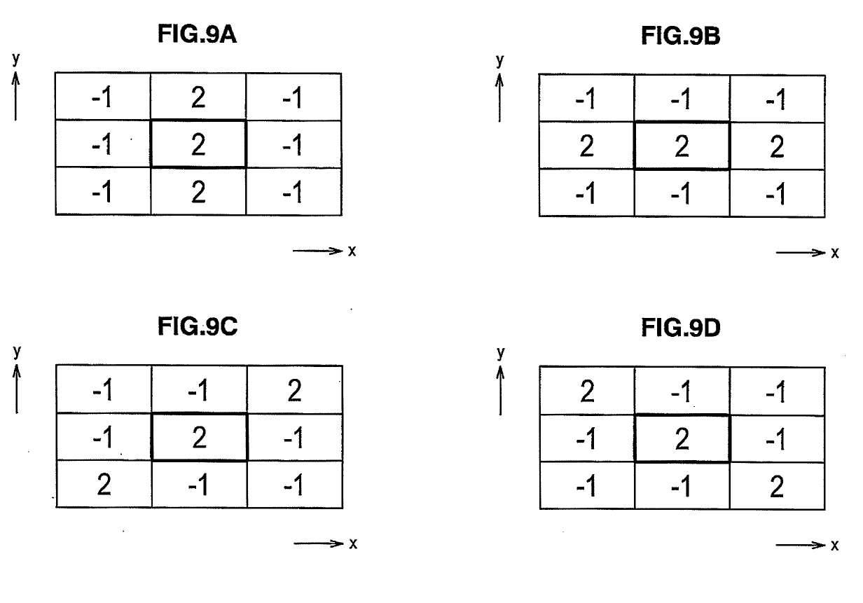

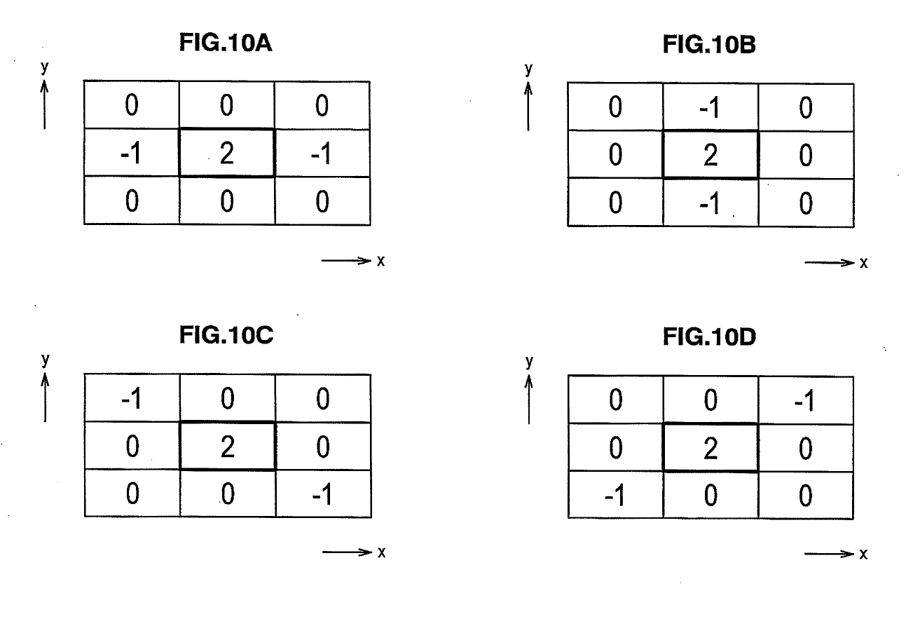

The image processing method for detecting a feature point on an image according to a second embodiment of the present invention is described below with reference to FIGS. 7 to 10D. The image processing method according to the second embodiment can be executed by the image processing apparatus 100 according to the first embodiment. However, the calculating amount can be further reduced in comparison with the first embodiment. Therefore, the image processing method according to the second embodiment is described below. FIG. 7 is a flow chart illustrating the image processing method according to the second embodiment. FIGS. 8A to 8D are explanatory diagrams illustrating one example of the filter for calculating the primary differential value according to the second embodiment. FIGS. 9A to 9D are explanatory diagrams illustrating one example of the filter for calculating the secondary differential value. FIGS. 10A to 10D are explanatory diagrams illustrating another example of the filter for calculating the second differential value.

In the image processing method according to the second embodiment, as shown in FIG. 7, the primary differential value on the peripheral area of the target pixel on the image is calculated, and the power P1 and the angle θ of the primary differential value are calculated (step S210). The level of the luminance change and the direction from the target pixel into the peripheral area on the image input from the image input section 110 are calculated at step S210. At this time, similarly to the first embodiment, the primary differential value is calculated by using filters having four directions as shown in FIGS. 8A to 8D, and the power P1 of the primary differentiation is calculated.

The filter used in the second embodiment is for an x direction (first direction) shown in FIG. 8A, a y direction (second direction) shown in FIG. 8B, a third direction shown in FIG. 8C (direction where FIG. 8A is rotated by 45° to a clockwise direction), and a fourth direction shown in FIG. 8D (direction where FIG. 8B is rotated by about 45° to the clockwise direction). These filters whose angles are different by 45°, and the primary differential value on the peripheral area of the target pixel 142 can be calculated at each 45°. At this time, the direction of the filter having the largest one of the four powers P1 of the primary differentiation calculated by using the filters, namely, the direction where the luminance change is the largest is determined as the direction of the primary differentiation. In such a manner, the power and the direction of the primary differentiation can be determined simultaneously at step S210.

The power P2 of the secondary differentiation is calculated (step S220). Inflection points with respect to the primary differential values calculated at step S210 are calculated. In the second embodiment, the values for the directions shifted from the primary differential value by about 90° (2/π) are calculated. The power P2 of the secondary differential value can be calculated by using filters shown in FIGS. 9A to 9D similarly to the first embodiment. That is to say, the filter for an x direction (first direction) shown in FIG. 9A, the filter for a y direction (second direction) shown in FIG. 9B, the filter for a third direction shown in FIG. 9C (direction where FIG. 9A is rotated by about 45° to a clockwise direction), and the filter for a fourth direction shown in FIG. 9D (direction where FIG. 9B is rotated by about 45° to the clockwise direction) are used. The filter which is vertical to the direction of the primary differential value calculated at step S210 is selected from the filters in FIGS. 9A to 9D, so that the secondary differential value can be calculated at step S220.

The filters used at step S220 can be designed as shown in FIGS. 10A to 10D. The filter which is vertical to the direction of the primary differential value is selected from the filters for the first to fourth directions show in FIGS. 10A to 10D, so that the secondary differential value may be calculated.

Thereafter, the corner portion 146 as the feature point is detected (step S230). Similarly to the detection of the feature point at step S140 of the first embodiment, feature point likeness is obtained based on the power P1 of the primary differentiation and the power P2 of the secondary differentiation according to the Formula 8 or 9. The corner portion 146 can be detected by executing the threshold process and the maximum value process on the output value of the feature point likeness.

The image processing method for detecting a feature point on the image according to the second embodiment is described above. According to the image processing method, the calculated results of the primary differentiation and the secondary differentiation on the peripheral area of the target pixel are combined, so that the feature point likeness can be detected. In addition to the easy process, the value and the angle of the primary differentiation can be calculated simultaneously. For this reason, the calculating amount can be further reduced, and the feature point can be detected sophisticatedly.

### Third Embodiment

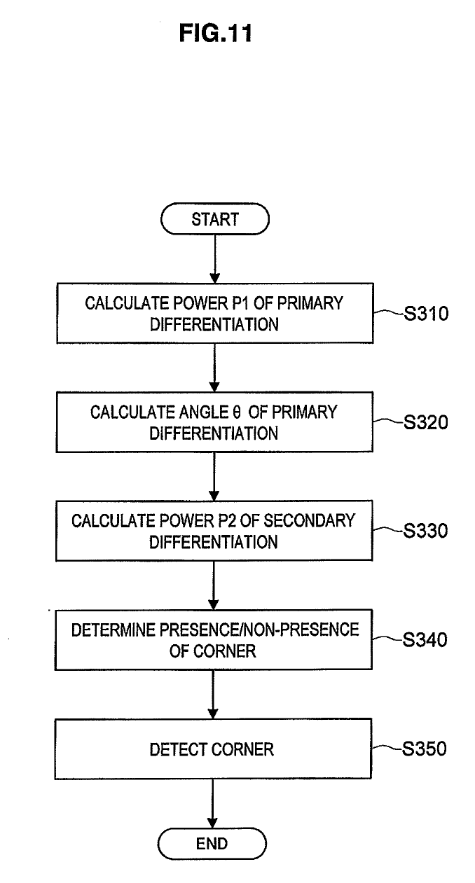

The image processing method according to a third embodiment of the present invention is described below with reference to FIG. 11. The image processing method according to the third embodiment can be executed by the image processing apparatus 100 according to the first embodiment, and in addition to the image processing method according to the first embodiment, a determination can be made whether the feature point is the edge portion 144 or the corner portion 146. A characteristic portion of the image processing method according to the third embodiment is described in detail below, and detailed description about the process which is the same as that in the first embodiment is omitted. FIG. 11 is a flow chart illustrating the image processing method according to the third embodiment.

In the image processing method according to the third embodiment, as shown in FIG. 11, the primary differential value on the peripheral area of the target pixel on the image is calculated, and the power P1 as the primary differential value is calculated (step S310). The level of the luminance change from the target pixel into the peripheral area on the image input from the image input section 110 is calculated at step S310. The x component gx and the y component gy of the primary differentiation on the input image I are calculated by using the filters shown in FIGS. 4A and 4B according to the Formulas 1 and 2. The power P1 of the primary differential value is calculated based on the calculated components of the primary differential value according to the Formula 3.

The angle θ of the primary differential value is calculated (step S320). A direction where the luminance change from the target pixel into the peripheral area on the image is large is calculated at step S320. The angle θ of the primary differential value is calculated according to the Formula 4.

The secondary differential value is calculated (step S330). The inflection point with respect to the primary differential value calculated at step S310 is calculated at step S330. In the third embodiment, the value for the direction shifted from the primary differential value by about 90° (2/π) is calculated. At this time, the power P2 of the secondary differential value can be calculated by using the filter L shown in FIG. 5 according to the Formulas 5 to 7.

Thereafter, presence/non-presence of the corner portion 146 as the feature point is determined (step S340). As shown in FIGS. 6B and 6C, a difference between the edge portion 144 and the corner portion 146 is the level of the power P2 of the secondary differentiation. That is to say, when the power P2 of the secondary differentiation is large, the feature point is the corner portion 146, and when it is small, the feature point is the edge portion 144. For example, the presence/non-presence of the corner portion can be determined based on a function z (P1, P2) shown in the following Formula 10.

### [Formula 6]

$$z ( P 1 , P 2 ) = \{ \begin{matrix}0 ( P 1 > k \cdot P 2 ) \\ 1 ( P 1 \leq k \cdot P 2 )\end{matrix} \qquad ( Formula 10 )$$

In the above Formula, k is a constant. That is to say, as to the function z (P1, P2), when a constant multiplication of the power P2 of the secondary differentiation is larger than the power P1 of the primary differentiation, the determination is made that feature point is the corner portion 146, and a value 1 is output. When the determination is made whether the power P2 is larger than the power P1 using the constant k, so that the determination can be made whether the feature point is the edge portion 144 or the corner portion 146.

The corner portion 146 is detected based on the output result of step S340 (step S350). For example, when the output value of the function z (P1, P2) is 0, the feature point is the edge portion 144, and when the output value of the function z (P1, P2) is 1, the feature point is the corner portion 146. When the determination is made that the feature point is the corner portion 146, information such that the corner portion 146 is present on the image is output from the output section 130.

The image processing method for detecting the feature point on the image according to the third embodiment is described above. According to the image processing method, the calculated results of the primary differentiation and the secondary differentiation on the peripheral area of the target pixel are combined, so that the feature point likeness can be detected. Since the feature point likeness can be detected by the simple process, it can be detected sophisticatedly with the less calculating amount. In the image processing apparatus according to the third embodiment, the presence/non-presence of the corner portion 146 is determined, so that the corner portion 146 can be detected as the feature point.

The process at steps S310 to S330 in the third embodiment is the same as the process at steps S110 to S130 in the first embodiment. However, the power P1 and the direction of the primary differentiation, and the power P2 of the secondary differentiation can be calculated also by using steps S210 and S220 in the image processing method according to the second embodiment. In this case, since the power and the angle of the primary differentiation can be calculated simultaneously, the calculating amount can be further reduced.

It should be understood by those skilled in the art that various modifications, combinations, sub-combinations and alterations may occur depending on design requirements and other factors insofar as they are writing the scope of the appended claims or the equivalents thereof.

In the above embodiments, the secondary differential value is calculated by using the filter which is vertical to the direction of the primary differential value, but the present invention is not limited to this example. For example, the filter whose direction is at an acute angle to the direction of the primary differential value may be used.

In the second embodiment, the filters which are used for calculating the primary differential value is designed so that their each direction is different by 45°, but the present invention is not limited to this. When the direction of the primary differential value is desired to be detected at a smaller interval (for example, 30°), a filter which is suitable for such a case may be designed.

What is claimed is:

1. An image processing apparatus comprising:
an image input section into which an image is input;
a primary differential value calculating section which calculates a primary differential value of luminance on a peripheral area of a target pixel as any one pixel on the input image;
a secondary differential value calculating section which calculates a secondary differential value with respect to the primary differential value; and
a detecting section which detects a feature point based on the primary differential value and the secondary differential value.

2. The image processing apparatus according to claim 1, wherein the primary differential value calculating section calculates largeness and a direction of the primary differential value.

3. The image processing apparatus according to claim 2, wherein the secondary differential value calculating section calculates the secondary differential value in a direction perpendicular to the primary differential value.

4. The image processing apparatus according to claim 2, wherein the detecting section determines a direction of the feature point based on the primary differential value.

5. The image processing apparatus according to claim 1, wherein the detecting section detects a pixel whose both primary differential value and secondary differential value become large as the feature point.

6. The image processing apparatus according to claim 5, wherein the detecting section detects a corner portion present on the image as the feature point.

7. The image processing apparatus according to claim 1, wherein the detecting section determines presence/non-presence of the feature point based on a ratio between the primary differential value and the secondary differential value of the luminance on the peripheral area of the target pixel.

8. An image processing method for detecting a feature point on an image, comprising the steps of:
calculating a primary differential value of luminance on a peripheral area of a target pixel as any one pixel on the image;
calculating a secondary differential value with respect to the primary differential value; and
detecting the feature point based on the primary differential value and the secondary differential value.

9. A computer program for operating a computer as an image processing apparatus capable of detecting a feature point on an image, comprising:
a primary differential value calculating unit which calculates a primary differential value of luminance on a peripheral area of a target pixel as any one pixel on the image;
a secondary differential value calculating unit which calculates a secondary differential value with respect to the primary differential value; and
a detecting unit which detects the feature point based on the primary differential value and the secondary differential value.
